(19) United States
(12) Patent Application Publication
(10) Pub. No.: US 2015/0122713 A1
(43) Pub. Date: May 7, 2015

(54) PRP OBTAINING DEVICE

(71) Applicants: Tan Wu, (US); Yung Kang Medical Device & Technologic Co., Ltd., Kaoshiung (TW)

(72) Inventor: Tan WU, Yuenlin Hsien (TW)

(73) Assignees: Yung Kang Medical Device & Technologic Co., Ltd., Kaoshiung (TW); Tan Wu, Yuenlin Hsien (TW)

(21) Appl. No.: 14/073,936

(22) Filed: Nov. 7, 2013

(51) Int. Cl. A61J 1/20

(52) U.S. Cl. CPC A61J 1/20; A61J 2001/2037; A61J 2001/2065
USPC 210/136

(57) ABSTRACT

A platelet rich plasma (PRP) obtaining device includes a container attached to a receptacle for allowing a material in the receptacle to flow into the container, a piston engaged in the receptacle for forcing the material to partially flow into the container, a housing slidably engaged in the container and having a space and having a tube extended in the housing, the tube includes a bore communicating with a compartment of the container, but offset from the space of the housing, and a check valve is attached to the housing for limiting the material to flow only from the container to the housing, and for preventing the material from flowing backward from the housing into the container.

### BACKGROUND OF THE INVENTION

1. Field of the Invention

The present invention relates to a platelet rich plasma (PRP) separating and obtaining device, and more particularly to a PRP separating and obtaining device including an improved structure or configuration for allowing the users to separate the PRP from the blood and plasma and to obtain the PRP easily by the users themselves.

2. Description of the Prior Art

Typically, platelet rich plasma (PRP) has been widely used for research, test, examination, inspection, surgical operation, orthopaedic surgical operation, cosmetic surgery, sports injury healing, scald healing, hair reconstruction purposes or the like, but the PRP may not be obtained and used unless the PRP is separated from the blood.

However, the PRP may only be separated from the blood with specialized equipment or facilities that may include a great cost and that may not be obtained by people.

The present invention has arisen to mitigate and/or obviate the afore-described disadvantages of the conventional PRP separating and obtaining devices.

### SUMMARY OF THE INVENTION

The primary objective of the present invention is to provide a PRP separating and obtaining device including an improved structure or configuration for allowing the users to separate the PRP from the blood and plasma and to obtain the PRP easily by the users themselves.

In accordance with one aspect of the invention, there is provided a PRP obtaining device comprising a receptacle including a chamber formed therein for receiving a material in the chamber of the receptacle, and including at least one opening formed in the receptacle and communicating with the chamber of the receptacle, a container pivotally engaged onto the receptacle, and including a compartment formed in the container, and including at least one aperture communicating with the compartment of the container for selectively aligning with the opening of the receptacle and for allowing the material contained in the receptacle to flow into the compartment of the container when the aperture of the container is aligned with the opening of the receptacle, the aperture of the container and the opening of the receptacle being allowed to be offset from each other for preventing the material from flowing between the chamber of the receptacle and the compartment of the container, a piston slidably received and engaged in the chamber of the receptacle and moveable relative to the receptacle for forcing the material to partially flow into the compartment of the container when the aperture of the container is aligned with the opening of the receptacle, a housing slidably engaged in the compartment of the container and partially extendible out of the container, and including a space formed in the housing and including a partition for spacing the space of the housing from the compartment of the container, and including a tube extended in the housing, the tube including a bore formed therein and communicating with the compartment of the container, but offset from the space of the housing, for allowing the material contained in the compartment of the container to flow out through the bore of the tube, and a check valve attached to the partition of the housing for limiting the material to flow only from the compartment of the container into the space of the housing, and for preventing the material from flowing backward from the housing into the container.

The receptacle includes a knob rotatably attached to the receptacle, the knob includes a threaded screw extended into the chamber of the receptacle and engaged with the piston for forcing the piston to move relative to the receptacle when the knob is rotated relative to the receptacle.

The receptacle includes a peripheral bulge, and the knob includes a peripheral depression formed therein and slidably engaged with the peripheral bulge of the receptacle for rotatably attaching the knob to the receptacle.

The receptacle includes a protrusion extended upwardly therefrom, and the opening of the receptacle is formed in the protrusion of the receptacle. The container includes a sleeve rotatably engaged onto the protrusion of the receptacle, and includes a plate attached to the container for engaging with the protrusion of the receptacle, and the aperture of the container is formed in the plate of the container.

The container includes a cap attached to the container and engageable with the housing for anchoring the housing to the container and for preventing the housing from being disengaged from the container. The housing includes a lock mechanism, and the cap includes a lock mechanism for engaging with the lock mechanism of the housing and for anchoring the housing to the container. The lock mechanisms of the housing and the cap are selected from a threaded portion.

The housing includes a board attached to an upper portion of the housing, and the board includes an opening formed therein for engaging with the tube and includes a passage formed in the board and communicating with the space of the housing. The board includes a pivot shaft, and a valve member includes a hole for engaging with the pivot shaft and for rotatably attaching the valve member to the board, the board includes two pathways formed therein for selectively communicating with the opening and the passage of the board respectively.

The housing includes a cover attached to an upper portion of the housing, and the cover includes two mouths provided thereon for selectively communicating with the pathways of the board. The cover includes a notch formed therein, and the valve member includes a hand grip extended outwardly therefrom and slidably engaged in the notch of the cover for limiting the valve member to pivot relative to the cover and the board and the housing.

The board includes a catch extended upwardly from the board for engaging with the cover and for retaining the cover to the board and the housing. The valve member includes two sealing members engaged into the pathways of the valve member for making a water tight seal between the cover and the valve member and the board.

The cover includes a lid for engaging with the mouths and for covering the mouths. The lid includes two plugs for engaging with the mouths and for sealing the mouths.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a PRP separating and obtaining device in accordance with the present invention;

FIG. 2 is a partial exploded view illustrating the operation of the PRP separating and obtaining device;

FIG. 3 is a cross sectional view of the PRP separating and obtaining device taken along lines 3-3 of FIG. 2;

FIGS. 4, 5, 6, 7 are cross sectional views similar to FIG. 3, illustrating the operation of the PRP separating and obtaining device;

FIG. 8 is a perspective view illustrating the operation of the PRP separating and obtaining device;

FIGS. 9, 10 are cross sectional views similar to FIGS. 3-7, illustrating the operation of the PRP separating and obtaining device;

FIG. 11 is another perspective view illustrating the operation of the PRP separating and obtaining device;

FIGS. 12, 13 are cross sectional views similar to FIGS. 3-7, and 9-10 illustrating the operation of the PRP separating and obtaining device;

FIG. 14 is an exploded view similar to FIG. 1, illustrating the other arrangement of the PRP obtaining device; and

FIG. 15 is a perspective view of the PRP separating and obtaining device as shown in FIG. 14.

### DETAILED DESCRIPTION OF THE PREFERRED EMBODIMENT

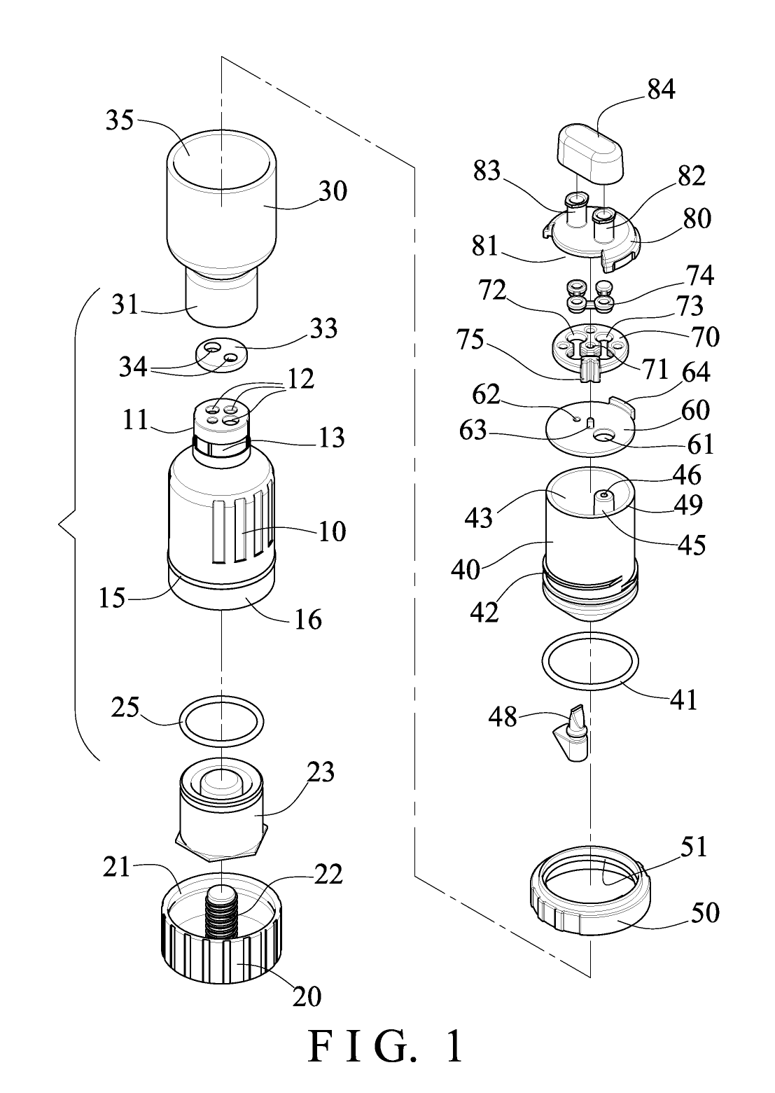

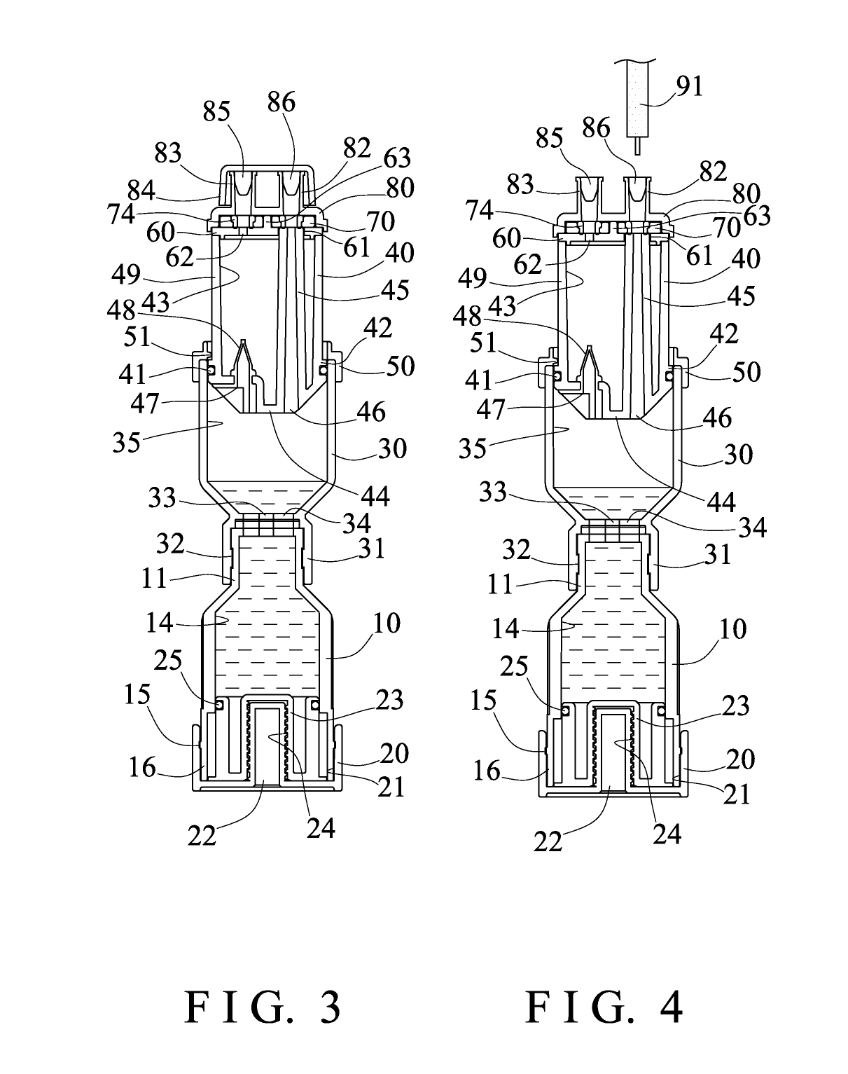

Referring to the drawings, and initially to FIGS. 1-3, a PRP separating and obtaining device in accordance with the present invention comprises a lower container or housing or receptacle 10 including a narrowed neck portion or mouth or hub or upper portion or protrusion 11 extended upwardly therefrom, and including one or more orifices or apertures or openings 12 formed therein, such as formed in the upper portion or in the protrusion 11, and including a peripheral depression or recess 13 formed in the outer peripheral portion of the protrusion 11, and including a compartment or chamber 14 formed in the receptacle 10 (FIGS. 3-7) and communicating with the openings 12 of the protrusion 11, and including a peripheral rib or flange or bulge 15 extended radially and outwardly from the lower or bottom portion of the receptacle 10.

A control ferrule or barrel or knob 20 includes a peripheral recess or depression 21 formed in the inner peripheral portion thereof for slidably receiving or engaging with the peripheral bulge 15 of the receptacle 10 and for allowing the knob 20 to be pivoted or rotated relative to the receptacle 10. The knob 20 includes a threaded member or bolt or screw 22 extended or provided therein and extended into the chamber 14 of the receptacle 10, and a follower or plug or piston 23 is slidably received or engaged in the chamber 14 of the receptacle 10 and includes a threaded or screw hole 24 formed therein for threading or engaging with the screw 22 and for allowing the piston 23 to be moved or slid relative to the receptacle 10 when the knob 20 is pivoted or rotated relative to the receptacle 10 by the user, for example. A sealing ring 25 may be provided and engaged between the receptacle 10 and the piston 23 for making an air or water tight seal between the receptacle 10 and the piston 23.

A receptacle or housing or container 30 includes a narrowed neck portion or mouth or sleeve 31 pivotally or rotatably engaged onto the protrusion 11 of the receptacle 10, and includes a peripheral rib or flange or bulge or swelling 32 provided and extended in the inner peripheral portion of the sleeve 31 for slidably receiving or engaging with the peripheral recess 13 of the protrusion 11 of the receptacle 10 and for pivotally or rotatably attaching or mounting or securing or engaging or coupling the container 30 to the receptacle 10, and includes a partition or board or plate 33 attached or mounted or secured in the sleeve 31 of the container 30 and/or formed integral with the container 30 and pivoted or rotated in concert with the sleeve 31 of the container 30 for contacting or engaging with the protrusion 11 of the receptacle 10. The plate 33 includes one or more orifices or openings or apertures 34 formed therein for selectively offset or aligning with the openings 12 of the protrusion 11 of the receptacle 10 when the container 30 is pivoted or rotated relative to the receptacle 10 by the user.

The container 30 includes a chamber or compartment 35 formed therein and communicating with the apertures 34 of the plate 33 for selectively communicating with the chamber 14 of the receptacle 10 when the apertures 34 of the plate 33 are aligned with or communicating with the openings 12 of the protrusion 11 of the receptacle 10, and for allowing the liquid or materials or fluid or the like contained in the receptacle 10 and the container 30 to flow between the receptacle 10 and the container 30, and the compartment 35 of the container 30 may be offset or separated from the chamber 14 of the receptacle 10 when the apertures 34 of the plate 33 are offset or separated from the openings 12 of the protrusion 11 of the receptacle 10 and when the container 30 is pivoted or rotated relative to the receptacle 10.

A receptacle or container or housing 40 is slidably received or engaged in the compartment 35 of the container 30 and partially movable or extendible out of the container 30 (FIGS. 3-11), and includes a sealing ring 41 provided and engaged between the housing 40 and the container 30 for making an air or water tight seal between the housing 40 and the container 30, and includes a latch or lock mechanism 42, such as a screw or threaded portion 42 formed or provided on the outer peripheral portion thereof. A cover or sleeve or control ferrule or cap 50 is attached or mounted or secured onto the container 30 and contacted or engageable with the housing 40 for anchoring or retaining or positioning the housing 40 to the container 30, and for preventing the housing 40 from being disengaged or separated from the container 30.

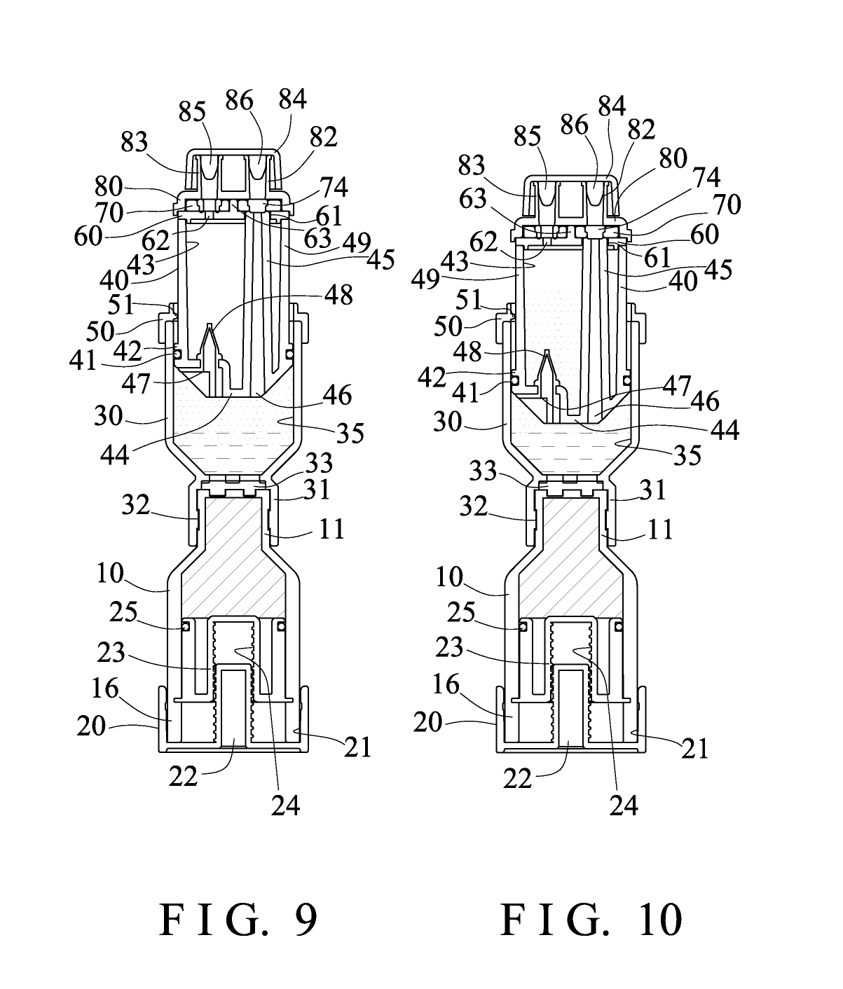

The cap 50 includes another latch or lock mechanism 51, such as a screw or threaded portion 51 formed or provided therein (FIG. 1) for threading or engaging with the screw or threaded portion or lock mechanism 42 of the housing 40 and for temporary anchoring or retaining or positioning the housing 40 to the container 30. For example, when the lock mechanism 42 of the housing 40 is engaged with the lock mechanism 51 of the cap 50, the housing 40 may be anchored or retained or positioned or latched or locked to the container 30 at the outwardly extending position as shown in FIGS. 3-8; and the housing 40 may be released and may be moved or engaged into the container 30 (FIGS. 9-10, 12-13) when the lock mechanism 42 of the housing 40 is disengaged from the lock mechanism 51 of the cap 50.

The housing 40 includes a bore or chamber or compartment or space 43 formed therein, and includes a bottom wall or partition 44 for spacing or separating the space 43 of the housing 40 from the compartment 35 of the container 30, and includes a bypass or tube 45 extended from the partition 44 of the housing 40 and extended into the space 43 of the housing 40, and the tube 45 includes a space or bore 46 formed therein and communicating with the compartment 35 of the container 30, but offset or separated from the space 43 of the housing 40 (FIGS. 3-7, 9-10, 12-13), for allowing the liquid or materials or fluid or the like contained in the compartment 35 of the container 30 to flow out through the bore 46 of the tube 45, without flowing out through or flowing into the space 43 of the housing 40. The housing 40 includes an opening or aperture or orifice 47 formed therein, such as formed in the partition 44 of the housing 40 for attaching or mounting or securing or engaging with a check valve 48 which may limit the liquid or materials or fluid or the like to flow from the container 30 into the housing 40 only.

A partition or plate or board 60 is attached or mounted or secured onto the upper portion 49 of the housing 40, and includes an opening 61 formed therein for receiving or engaging with the upper portion of the tube 45, and includes an opening or aperture or orifice or passage 62 formed therein and communicating with the space 43 of the housing 40, and includes a pivot shaft 63 extended upwardly from a center portion of the board 60, and includes one or more stops or latches or catches 64 extended upwardly from an outer peripheral portion of the board 60 for latching or catching or anchoring or retaining or positioning a cover 80 to the board 60 and the housing 40. The cover 80 is also attached or mounted or secured onto the upper portion 49 of the housing 40 and includes a channel or notch 81 formed in the outer peripheral portion thereof, and includes one or more (such as two) hubs or tubes or mouths 82, 83 formed or provided thereon.

A cap or cover or hood or lid 84 may be provided for covering or shielding the mouths 82, 83, and includes one or more (such as two) plugs 85, 86 extended or provided therein for plugging or engaging with the mouths 82, 83 and for selectively sealing the mouths 82, 83. A follower or valve piece or valve member 70 is pivotally or rotatably received or engaged in the cover 80, and includes a hole 71 formed in the center portion of the valve member 70 for receiving or engaging with the pivot shaft 63 and for limiting or guiding the valve member 70 to pivot or rotate relative to the cover 80 and the board 60 and the housing 40, and includes one or more (such as two) openings or apertures or orifices or passages or pathways 72, 73 formed therein for selectively communicating with the mouths 82, 83 and/or the opening 61 and the passage 62 of the board 60 respectively.

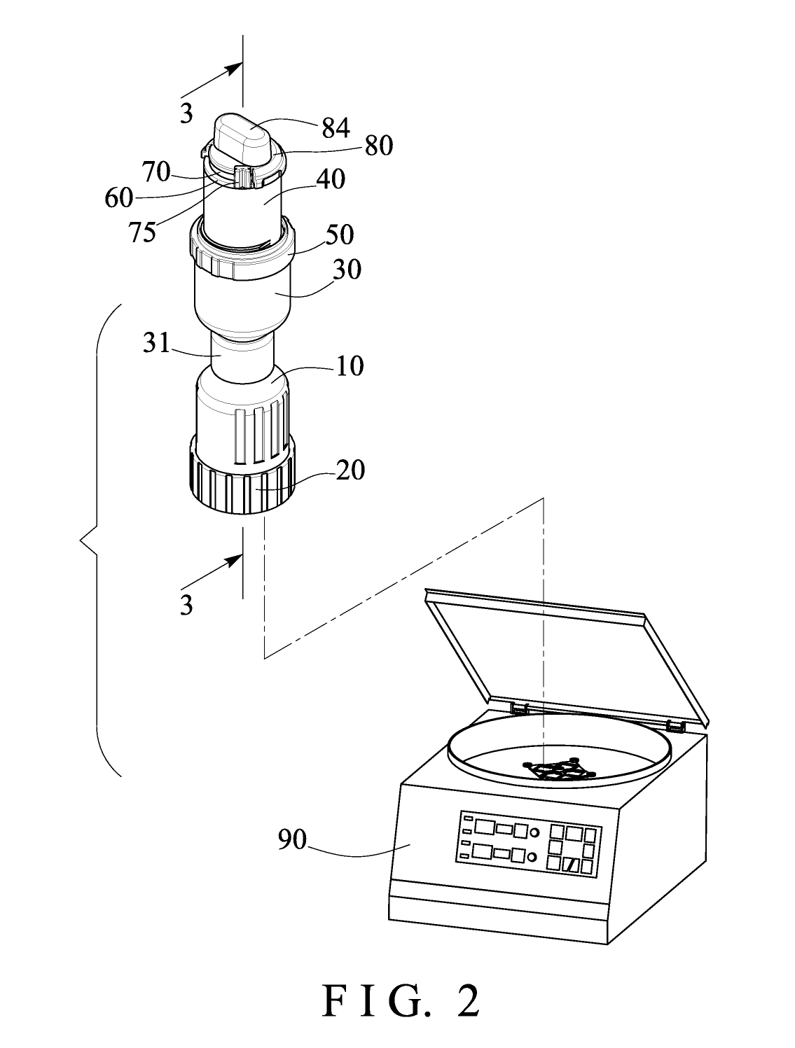

One or more (such as two) pads or sealing rings or sealing members 74 are provided and engaged into the pathways 72, 73 of the valve member 70 for making an air or water tight seal between the cover 80 and the valve member 70 and/or between the valve member 70 and the board 60. The valve member 70 includes a knob or extension or hand grip 75 extended outwardly therefrom and slidably received or engaged in the notch 81 of the cover 80 for limiting or guiding the valve member 70 to pivot or rotate relative to the cover 80 and the board 60 and the housing 40, the hand grip 75 may be used for pivoting or rotating the valve member 70 relative to the cover 80 and the board 60 for selectively communicating the pathways 72, 73 of the valve member 70 with the mouths 82, 83 and/or the opening 61 and the passage 62 of the board 60 respectively. As shown in FIG. 2, a separator 90, such as a centrifugal separator 90 may be provided for engaging with and for moving or oscillating or vibrating the receptacle 10 and the container 30 and the housing 40.

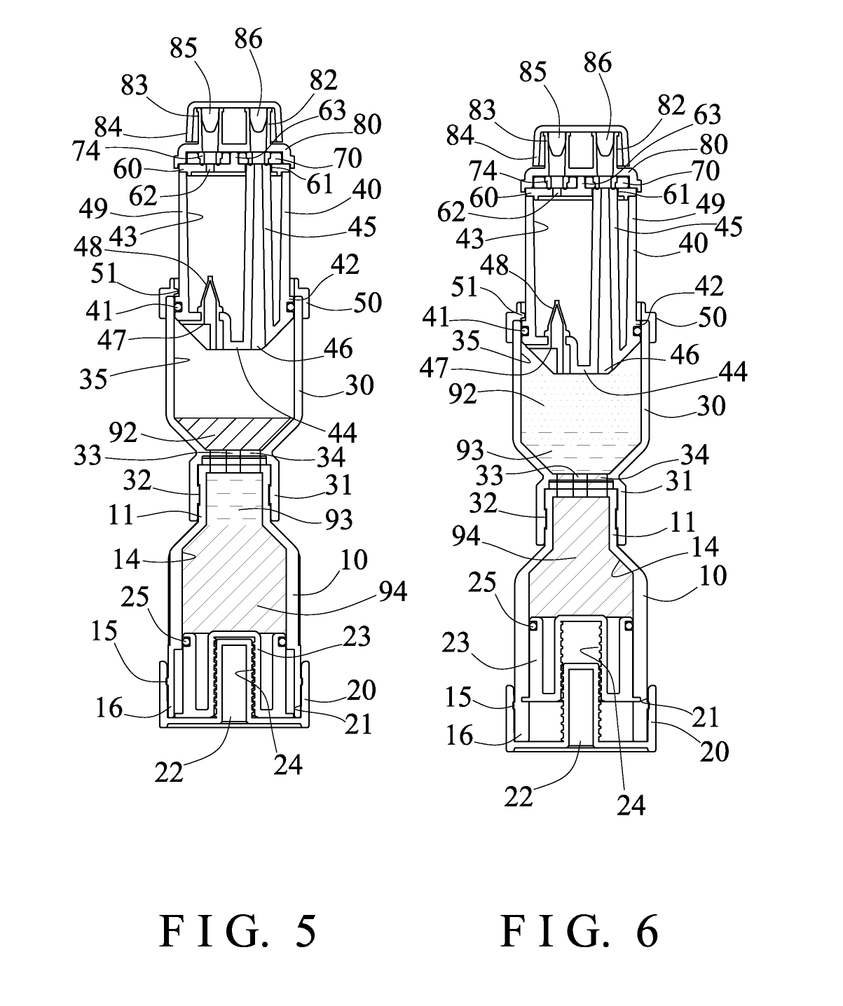

In operation, as shown in FIG. 4, a needle or syringe 91 may be used to draw and obtain the blood from the user and to engage into one of the mouths 82 of the cover 80 and then into the tube 45, for filling or supplying or injecting the blood into the bore 46 of the tube 45 and then into the compartment 35 of the container 30 and into the chamber 14 of the receptacle 10, and the plugs 85, 86 of the lid 84 may then be plugged or engaged with the mouths 82, 83 for selectively sealing the mouths 82, 83 of the cover 80 (FIG. 3). The receptacle 10 and the container 30 and the housing 40 of the PRP separating and obtaining device may then be attached to or engaged with the separator 90 for being oscillated or vibrated by the separator 90, and for oscillating or vibrating the blood and for separating the blood into three layers, including an upper layer of platelet poor plasma (PPP) 92, a middle or intermediate layer of platelet rich plasma (PRP) 93, and a lower layer of blood cells 94 (FIG. 5).

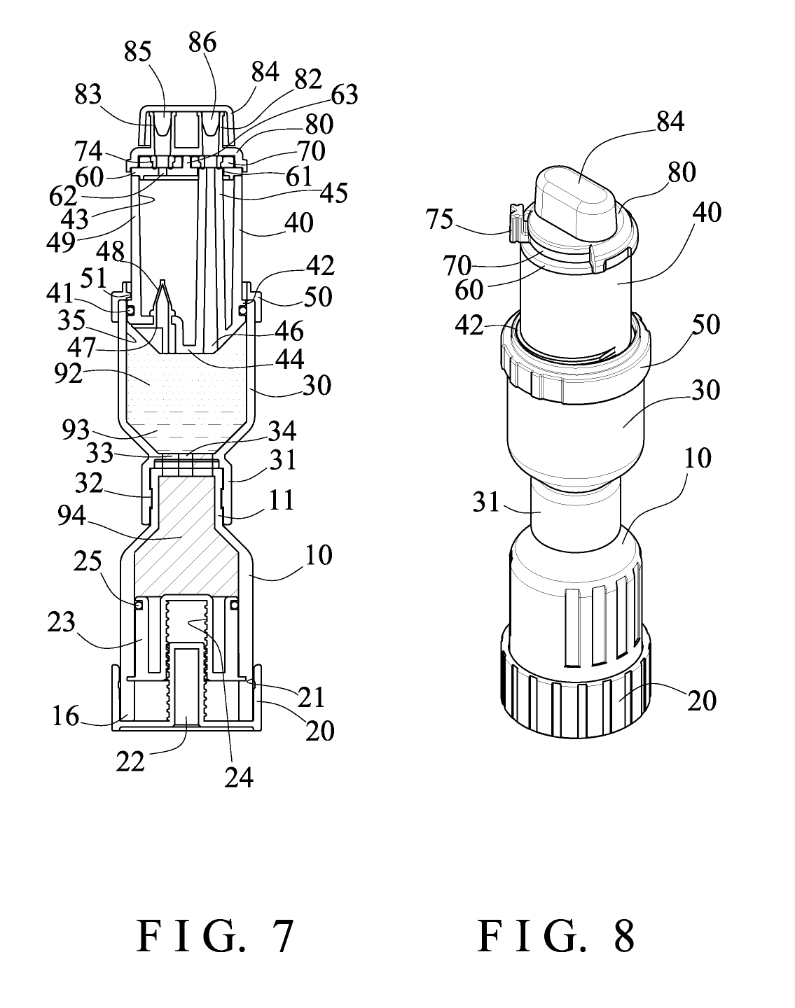

As shown in FIG. 6, the knob 20 may then be pivoted or rotated relative to the receptacle 10 in order to force the piston 23 to move or slide relative to the receptacle 10 or into the chamber 14 of the receptacle 10 and to force or move the PPP layer 92 and the PRP layer 93 into the compartment 35 of the container 30, and to keep or retain the blood cell layer 94 within the chamber 14 of the receptacle 10. The container 30 and the receptacle 10 may then be pivoted or rotated relative to each other to offset or separate the apertures 34 of the plate 33 from the openings 12 of the protrusion 11 of the receptacle 10 (FIG. 7), and to keep or retain the blood cell layer 94 within the chamber 14 of the receptacle 10, and also to keep or retain the PPP layer 92 and the PRP layer 93 within the compartment 35 of the container 30.

As shown in FIGS. 8-10, it is preferable that the valve member 70 is pivoted or rotated relative to the cover 80 and the board 60 with the hand grip 75 in order to offset or separate the pathways 72, 73 of the valve member 70 from the mouths 82, 83 and/or the opening 61 and the passage 62 of the board 60 respectively. The receptacle 10 and the container 30 and the housing 40 of the PRP separating and obtaining device may then be attached to or engaged with the separator 90 again for oscillating or vibrating the blood and for further separating the upper layer of platelet poor plasma (PPP) 92 from the middle or intermediate layer of platelet rich plasma (PRP) 93. The housing 40 may then be pivoted or rotated relative to the container 30 in order to disengage the lock mechanism 42 of the housing 40 from the lock mechanism 51 of the cap 50.

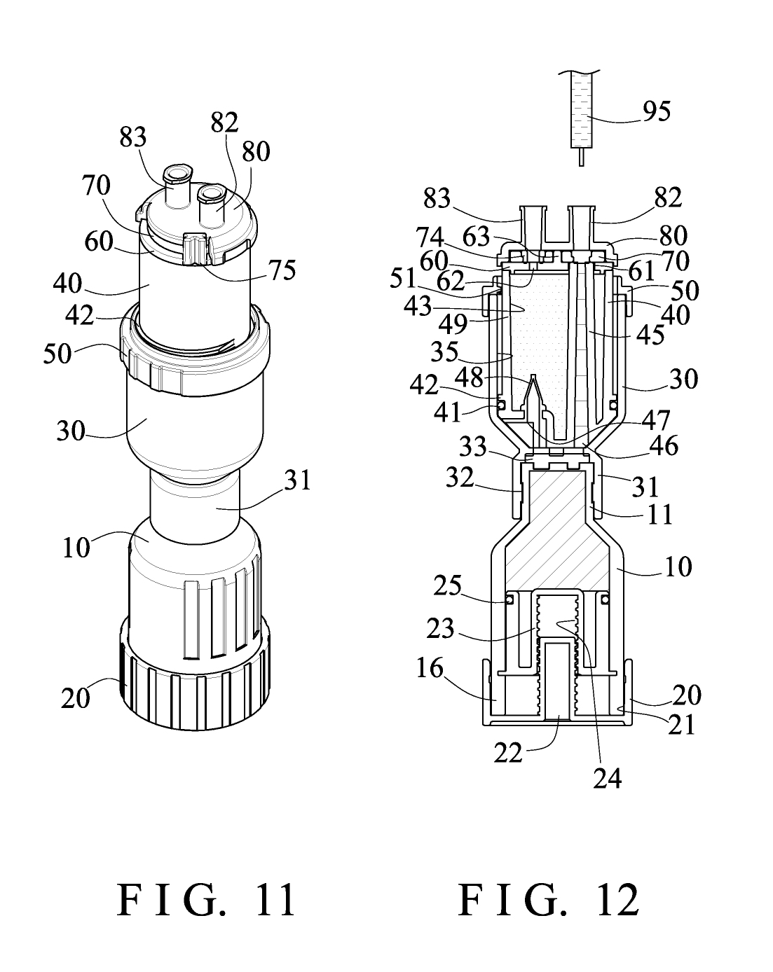

As shown in FIG. 9, the housing 40 may then be forced to move into the compartment 35 of the container 30 in order to force the upper PPP layer 92 to flow through the orifice 47 of the partition 44 of the housing 40 and to flow through the check valve 48 and then to flow into the space 43 of the housing 40 (FIG. 10), the PRP layer 93 may thus be kept and retained within the compartment 35 of the container 30, such that the upper PPP layer 92 and the middle or intermediate PRP layer 93 and the lower blood cell layer 94 may be kept and retained within the housing 40 and the container 30 and the receptacle 10 respectively. As shown in FIG. 11, the valve member 70 may then be pivoted or rotated relative to the cover 80 and the board 60 with the hand grip 75 again in order to selectively align and communicate the pathways 72, 73 of the valve member 70 with the mouths 82, 83 and/or the opening 61 and the passage 62 of the board 60 respectively.

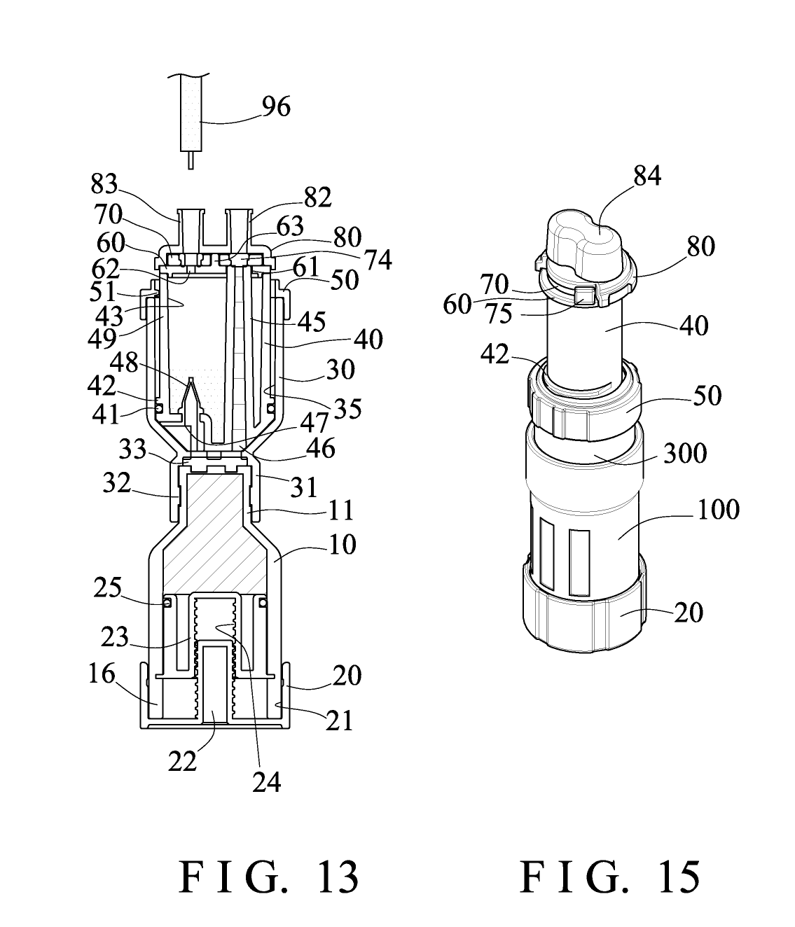

As shown in FIG. 12, another needle or syringe 95 may be engaged into one of the mouths 82 of the cover 80 and then into the tube 45, for drawing or obtaining the PRP layer 93, and a further needle or syringe 96 (FIG. 13) may be engaged into the other mouths 83 of the cover 80 and then through the passage 62 of the board 60 and then into the space 43 of the housing 40 for drawing or obtaining the PPP layer 92. The receptacle 10 may be threaded or disengaged or separated from the container 30 in order to fetch or obtain the blood cell layer 94 that is contained within the chamber 14 of the receptacle 10. It is to be noted that the receptacle 10 and the container 30 and the housing 40 of the PRP separating and obtaining device may be easily available for the public or the users with a much decreased cost.

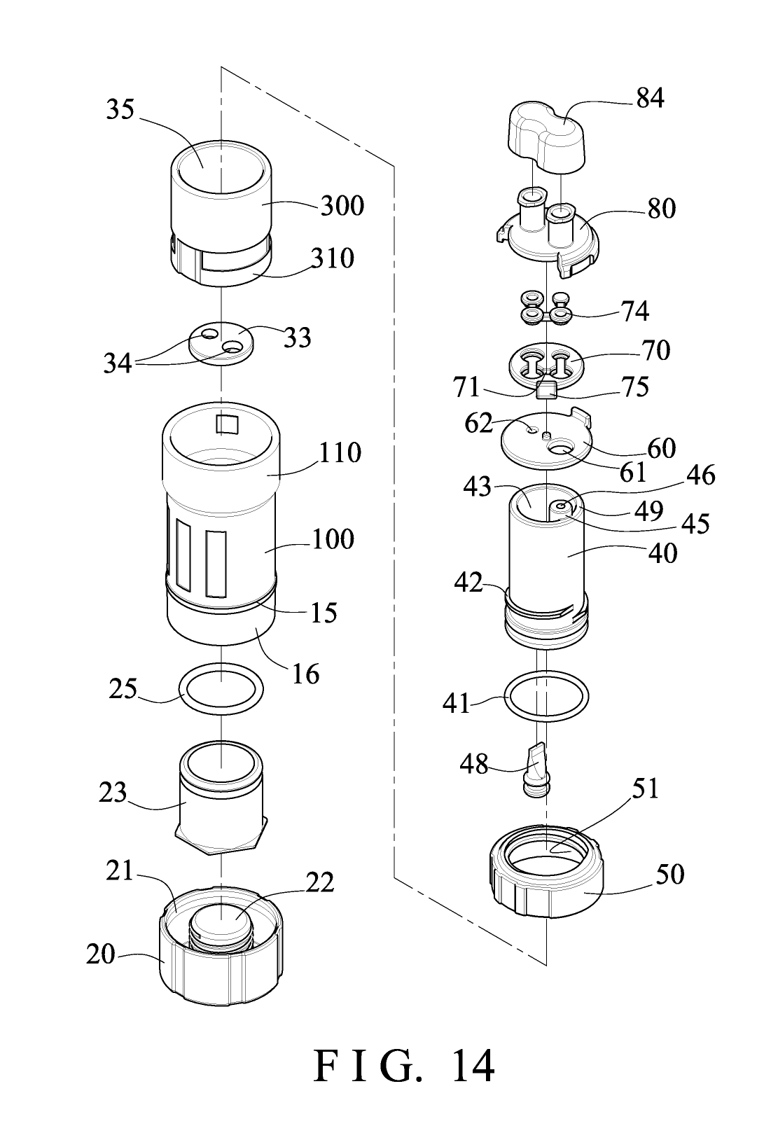

Alternatively, as shown in FIGS. 14 and 15, the sleeve 310 of the container 300 may include a size or dimension or outer diameter smaller than an inner diameter of the protrusion 110 of the receptacle 100 for allowing the sleeve 310 of the container 300 to be pivotally or rotatably engaged onto the protrusion 110 of the receptacle 100, and the other structure or configuration or parts or elements of the PRP separating and obtaining device may be the same for allowing the upper PPP layer 92 and the middle or intermediate PRP layer 93 and the lower blood cell layer 94 also to be kept and retained within the housing 40 and the container 300 and the receptacle 100 respectively.

Accordingly, the PRP separating and obtaining device in accordance with the present invention includes an improved structure or configuration for allowing the users to separate the PRP from the blood and plasma and to obtain the PRP easily by the users themselves.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A PRP obtaining device comprising:
a receptacle including a chamber formed therein for receiving a material in said chamber of said receptacle, and including at least one opening formed in said receptacle and communicating with said chamber of said receptacle,
a container pivotally engaged onto said receptacle, and including a compartment formed in said container, and including at least one aperture communicating with said compartment of said container for selectively aligning with said at least one opening of said receptacle and for allowing the material contained in said receptacle to flow into said compartment of said container when said at least one aperture of said container is aligned with said at least one opening of said receptacle, said at least one aperture of said container and said at least one opening of said receptacle being allowed to be offset from each other for preventing the material from flowing between said chamber of said receptacle and said compartment of said container,
a piston slidably received and engaged in said chamber of said receptacle and moveable relative to said receptacle for forcing the material to partially flow into said compartment of said container when said at least one aperture of said container is aligned with said at least one opening of said receptacle,
a housing slidably engaged in said compartment of said container and partially extendible out of said container, and including a space formed in said housing and including a partition for spacing said space of said housing from said compartment of said container, and including a tube extended in said housing, said tube including a bore formed therein and communicating with said compartment of said container, but offset from said space of said housing, for allowing the material contained in said compartment of said container to flow out through said bore of said tube, and
a check valve attached to said partition of said housing for limiting said material to flow only from said compartment of said container into said space of said housing, and for preventing the material from flowing backward from said space of said housing into said compartment of said container.

2. The PRP obtaining device as claimed in claim 1, wherein said receptacle includes a knob rotatably attached to said receptacle, said knob includes a threaded screw extended into said chamber of said receptacle and engaged with said piston for forcing said piston to move relative to said receptacle when said knob is rotated relative to said receptacle.

3. The PRP obtaining device as claimed in claim 2, wherein said receptacle includes a peripheral bulge extended radially and outwardly from said receptacle, and said knob includes a peripheral depression formed therein and slidably engaged with said peripheral bulge of said receptacle for rotatably attaching said knob to said receptacle.

4. The PRP obtaining device as claimed in claim 1, wherein said receptacle includes a protrusion extended upwardly therefrom, and said at least one opening of said receptacle is formed in said protrusion of said receptacle.

5. The PRP obtaining device as claimed in claim 4, wherein said container includes a sleeve rotatably engaged onto said protrusion of said receptacle, and includes a plate attached to said container for engaging with said protrusion of said receptacle, and said at least one aperture of said container is formed in said plate of said container.

6. The PRP obtaining device as claimed in claim 1, wherein said container includes a cap attached to said container and engageable with said housing for anchoring said housing to said container and for preventing said housing from being disengaged from said container.

7. The PRP obtaining device as claimed in claim 6, wherein said housing includes a lock mechanism, and said cap includes a lock mechanism for engaging with said lock mechanism of said housing and for anchoring said housing to said container.

8. The PRP obtaining device as claimed in claim 7, wherein said lock mechanisms of said housing and said cap are selected from a threaded portion.

9. The PRP obtaining device as claimed in claim 1, wherein said housing includes a board attached to an upper portion of said housing, and said board includes an opening formed therein for engaging with said tube and includes a passage formed in said board and communicating with said space of said housing.

10. The PRP obtaining device as claimed in claim 9, wherein said board includes a pivot shaft extended upwardly therefrom, and a valve member includes a hole formed therein for engaging with said pivot shaft and for rotatably attaching said valve member to said board, said board includes two pathways formed therein for selectively communicating with said opening and said passage of said board respectively.

11. The PRP obtaining device as claimed in claim 10, wherein said housing includes a cover attached to an upper portion of said housing, and said cover includes two mouths provided thereon for selectively communicating with said pathways of said board.

12. The PRP obtaining device as claimed in claim 11, wherein said cover includes a notch formed therein, and said valve member includes a hand grip extended outwardly therefrom and slidably engaged in said notch of said cover for limiting said valve member to pivot relative to said cover and said board and said housing.

13. The PRP obtaining device as claimed in claim 11, wherein said board includes a catch extended upwardly from said board for engaging with said cover and for retaining said cover to said board and said housing.

14. The PRP obtaining device as claimed in claim 11, wherein said valve member includes two sealing members engaged into said pathways of said valve member for making a water tight seal between said cover and said valve member and said board.

15. The PRP obtaining device as claimed in claim 11, wherein said cover includes a lid for engaging with said mouths and for covering said mouths.

16. The PRP obtaining device as claimed in claim 15, wherein said lid includes two plugs for engaging with said mouths and for sealing said mouths.
